(19) United States
(12) Patent Application Publication
(10) Pub. No.: US 2002/0188436 A1
(43) Pub. Date: Dec. 12, 2002

(54) Nth- order fractal network for handling complex structures

(76) Inventors: Gunter Schmidt, Unterhaching (DE); Maria Athelogou, Munchen (DE); Martin Baatz, Munchen (DE); Andrej Kharadi, Berlin (DE); Jurgen Klenk, Grobenzell (DE); Peter Blochl, Goslar (DE); Gerd Binnig, Wollerau (CH)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/197,150

(22) Filed: Jul. 15, 2002

Related U.S. Application Data
(63) Continuation of application No. 09/806,727, filed on Jul. 9, 2001.
Application No. 09/806,727 is a 371 of international application No. PCT/EP99/07137, filed on Sep. 24, 1999.

(30) Foreign Application Priority Data
Feb. 10, 1998 (DE) 198 45 555.0
Feb. 25, 1999 (DE) 199 08 204.9

(51) Int. Cl. G06F 17/20

(52) U.S. Cl. 704/1

(57) ABSTRACT

A fractal network for handling complex structures is disclosed, which is comprised of a multiplicity of units. The fractal network contains both semantic units each possessing informational contents and linking units describing a relational content. The relational content links two respective semantic units in such a manner that the mutual relation of the two linked semantic units is determined by the relational content.

The invention relates to an nth-order fractal network for handling complex structures and in particular to a fractal or fractal-hierarchical network having a multiplicity of semantic units, whereby semantically structured information may be analyzed and treated.

Concurrently with a progressive transformation of the industrial society towards the information society, there is an increasing need for a tool to process the growing flood of information. Particularly in the field of image recognition, speech recognition and simulation, comprehensive investigations were carried out to make possible a simplification in the recognition, modification and utilization of complex structures such as, for example, speech and images.

The like systems in the prior art do, however, suffer from poor flexibility and extraordinarily complicated provision and processing of the data or information used. The data to be processed are moreover essentially static.

Particularly in the case of dynamic complex structures or of chaotic technical systems, processing of—such data is extraordinarily difficult or even impossible.

In the prior art it is furthermore known to handle informational contents in a structured manner with the aid of the data description language XML or extended Markup Language (derived from SGML, IS08879), respectively. Structuring herein may be semantic. “Semantic” here means that references of an informational content to other informational contents may carry a meaning. Herein it is possible to formulate meta-data, i.e., data describing data. In the data description language XML it is, however, not possible to store information about processes in a way that would enable this very information to enter into a data analysis and into an “intelligent” behavior of a semantic network.

The prior art currently employed in the field of knowledge about processes is reflected in methods and processes for pattern recognition and simulation. Even though currently employed methods are, as it were, quite mature, there is no knowledge whatsoever about objects within their semantic contexts. In a simple illustrative contemplation it may thus be said that a presently employed pattern recognition is, for example, not cognizant of the facts that “a coniferous wood in general is a wood” and that “bridges frequently span rivers”.

The present invention is therefore based on the object of furnishing an n^{th}-order fractal network for handling complex structures which makes it possible to store information or knowledge in a structured form, and by means thereof analyze data and link them therewith.

This object of the present invention is attained through the features set forth in claim 1.

More precisely, in accordance with the present invention a fractal network for handling complex structures is furnished which consists of a multiplicity of units. The fractal network contains both semantic units each possessing informational contents, and linking units describing a respective relational content. The relational content links two respective semantic units in such a way that the mutual relation of the two linked semantic units is determined by the relational content.

A central element herein is the semantic unit representing an “object” or a “process of the world” as a data structure. An essential feature of the semantic unit is the ability to store informational contents in a structured manner and to mesh or cross-link with other semantic units. In order for two semantic units to be linked in such a way that the combination will carry a meaning or will be semantic, these semantic units are connected among each other through the specialized linking units. A like linking unit may, for example, also be implicitly provided in a structured informational content of a semantic unit.

These linking units can be a particular form of semantic units which may possess informational contents and relational contents.

In order to be able to carry out non-ambiguous operations in the “world knowledge” present in the fractal network, an identification which is unique within this “world knowledge” may be allocated to each semantic unit.

There moreover exists a possibility of creating a data structure which makes it possible at any time to alter information or knowledge already existing in the fractal network and to add new parts. Due to the fact that the knowledge encompasses not only information about objects but also knowledge about information-processing processes, it is possible to alter content and structure of the knowledge in a dynamic procedure.

Complex structures may represent speech, images, networks or chaotic systems such as, e.g., technical, cultural, economic or ecological contexts.

Further advantageous developments of the present invention are subject matters of the subclaims.

The present invention shall in the following be explained in more detail by way of embodiments while referring to the annexed drawing, wherein:

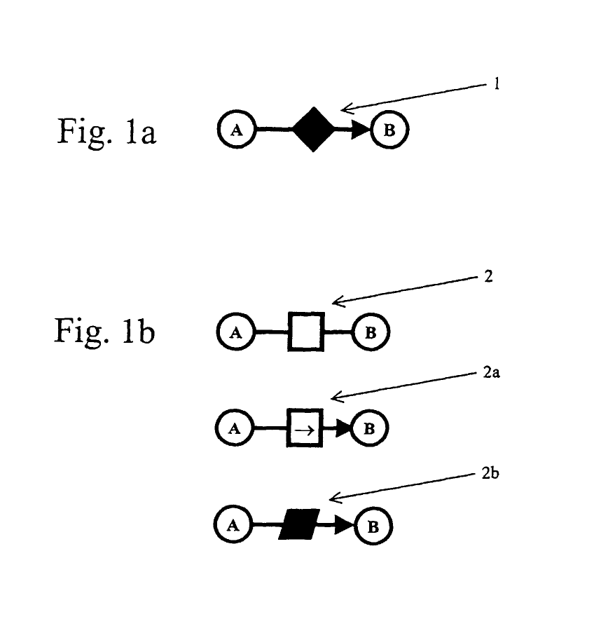

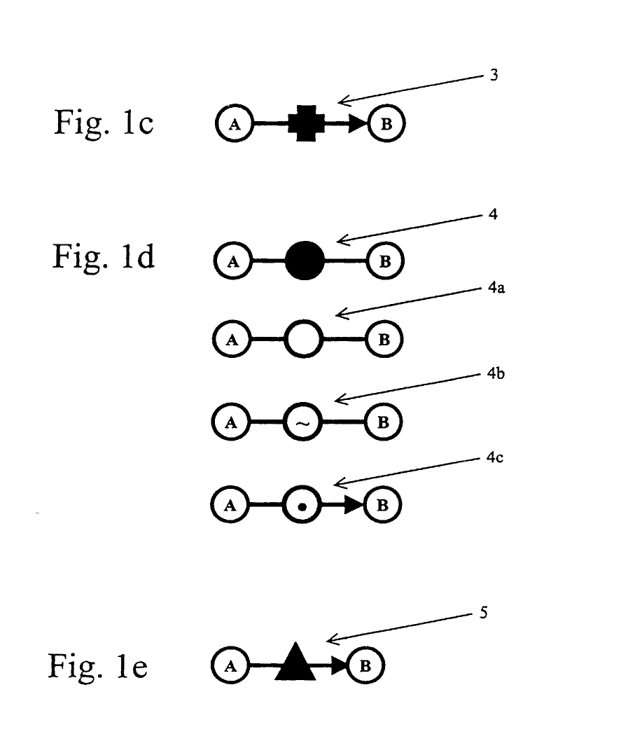

FIGS. 1a to 1e show various types of linking units utilized in the embodiments of the present invention;

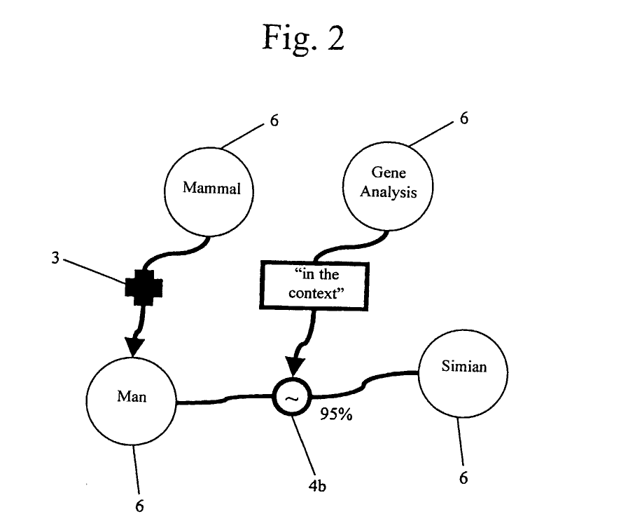

FIG. 2 is a representation of an nth-order fractal network in accordance with a first embodiment of the present invention;

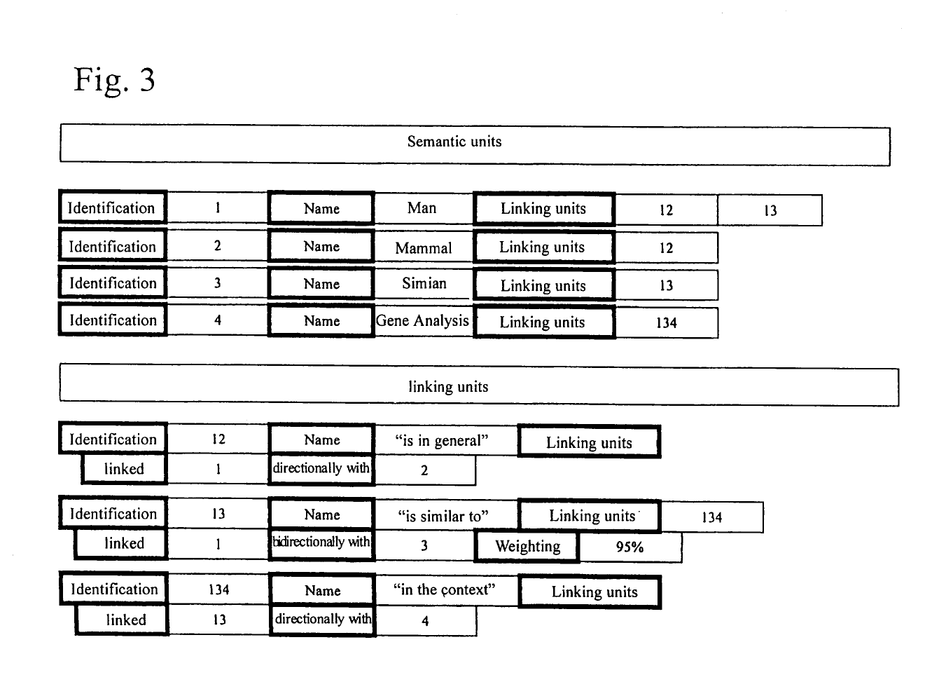

FIG. 3 shows structured informational contents and relational contents in semantic units and linking units, respectively, in accordance with the first embodiment of the present invention;

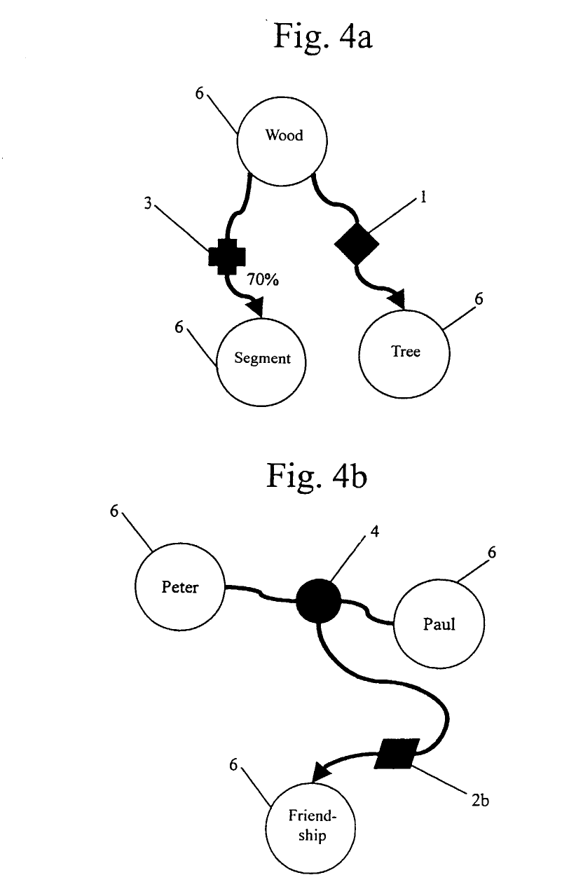

FIGS. 4a and 4b are representations of further fractal networks in accordance with the first embodiment of the present invention;

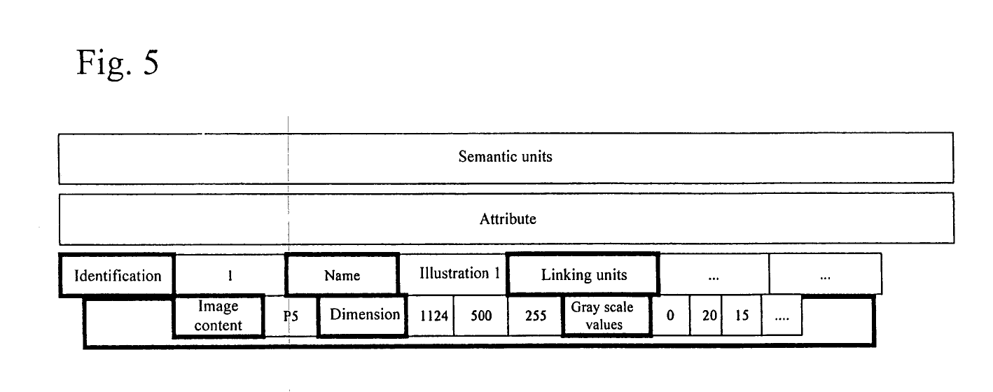

FIG. 5 shows structured informational contents in semantic units having attributes in accordance with the first embodiment of the present invention;

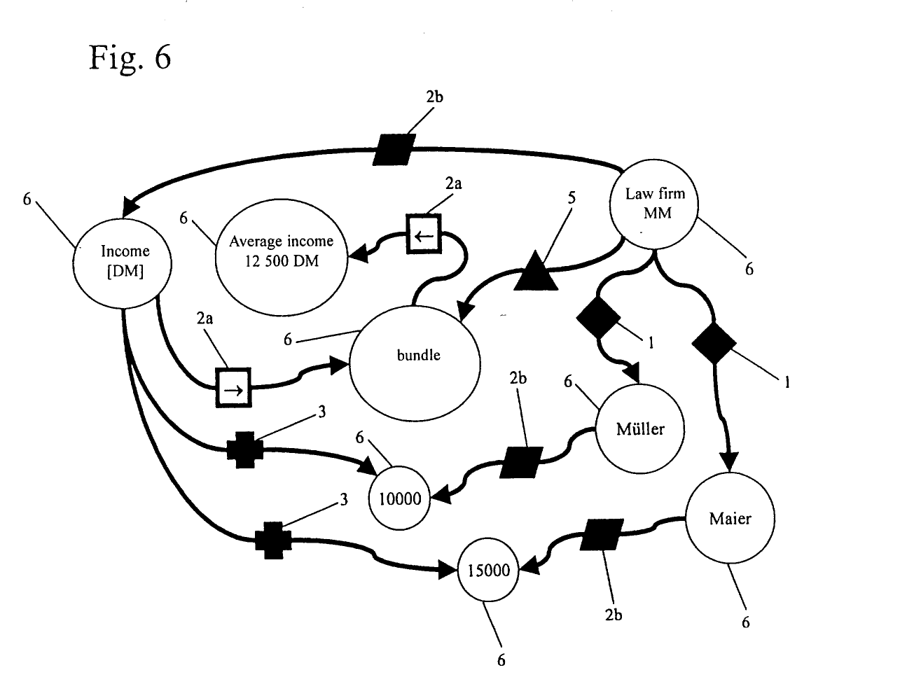

FIG. 6 is a representation of an nth-order fractal network in accordance with a second embodiment of the present invention;

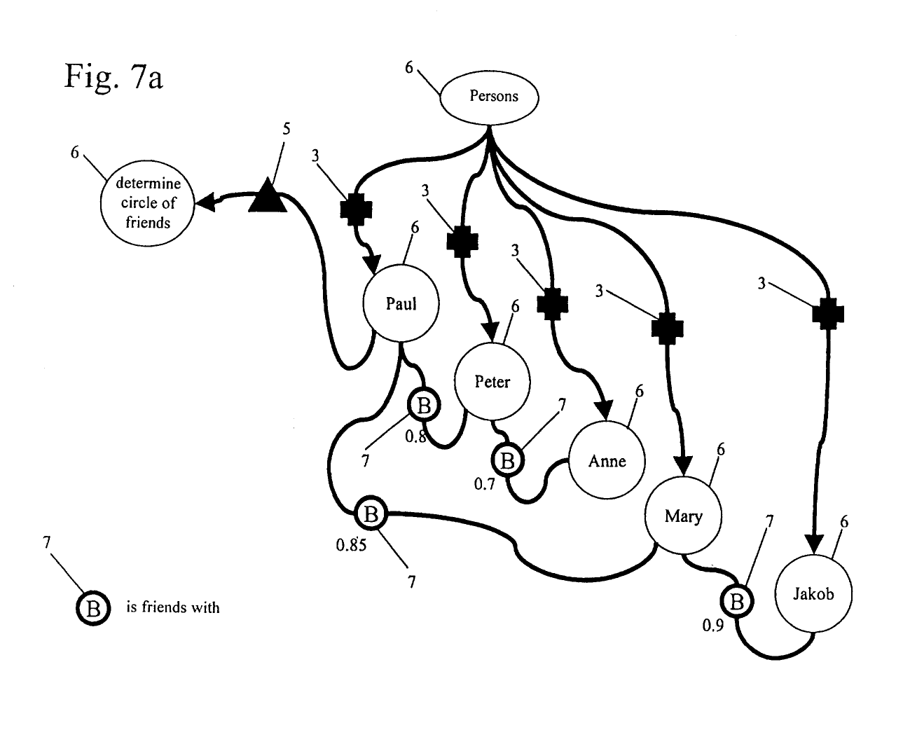

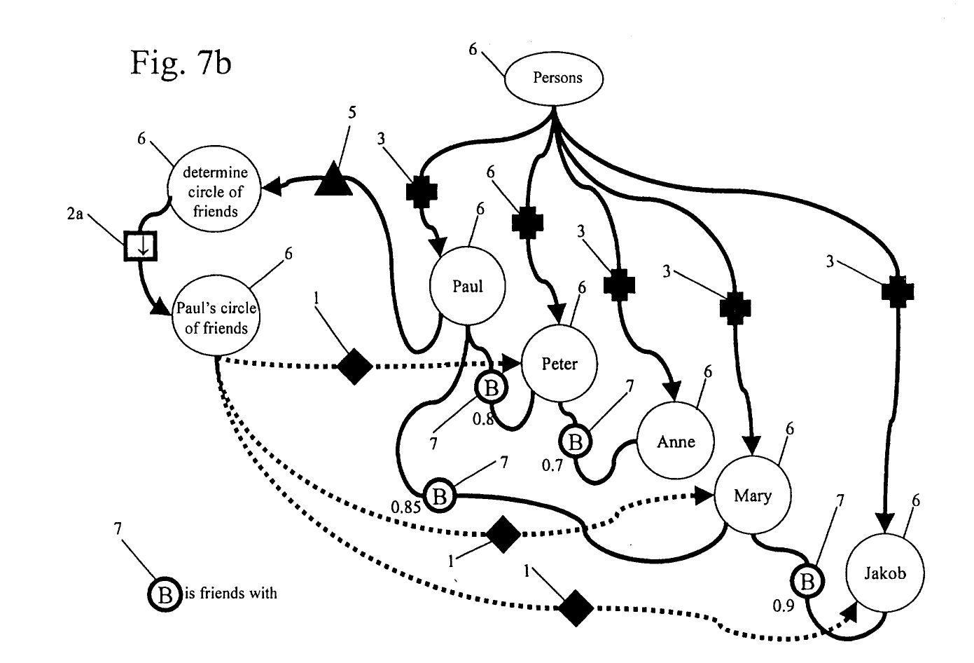

FIGS. 7a and 7b are representations of a semantic network in accordance with a third embodiment of the present invention;

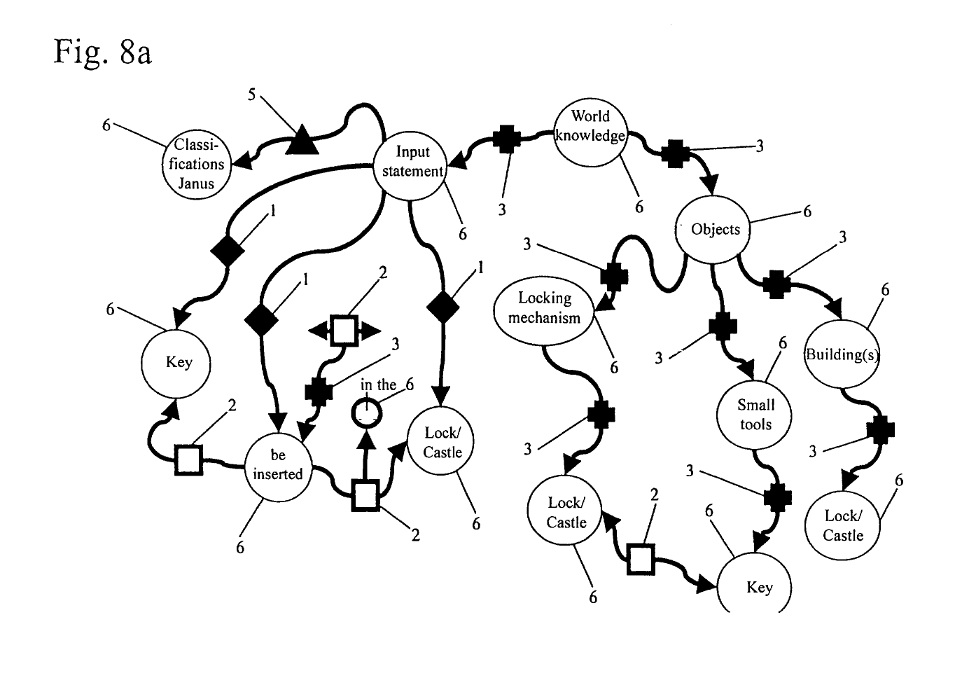

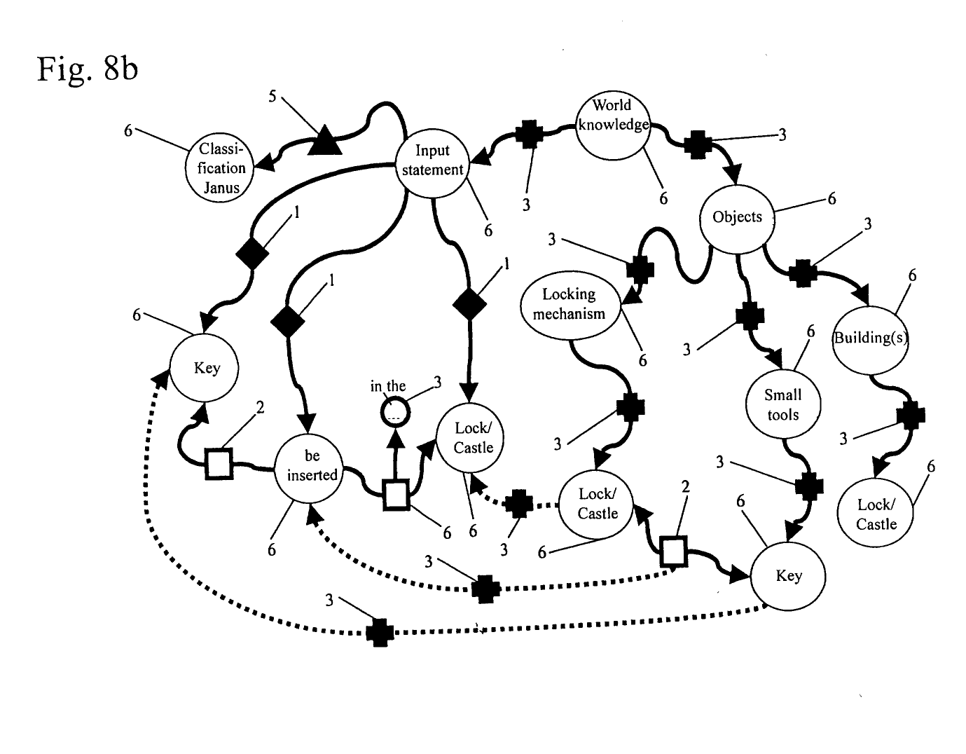

FIGS. 8a and 8b are representations of a semantic network in accordance with a fourth embodiment of the present invention; and

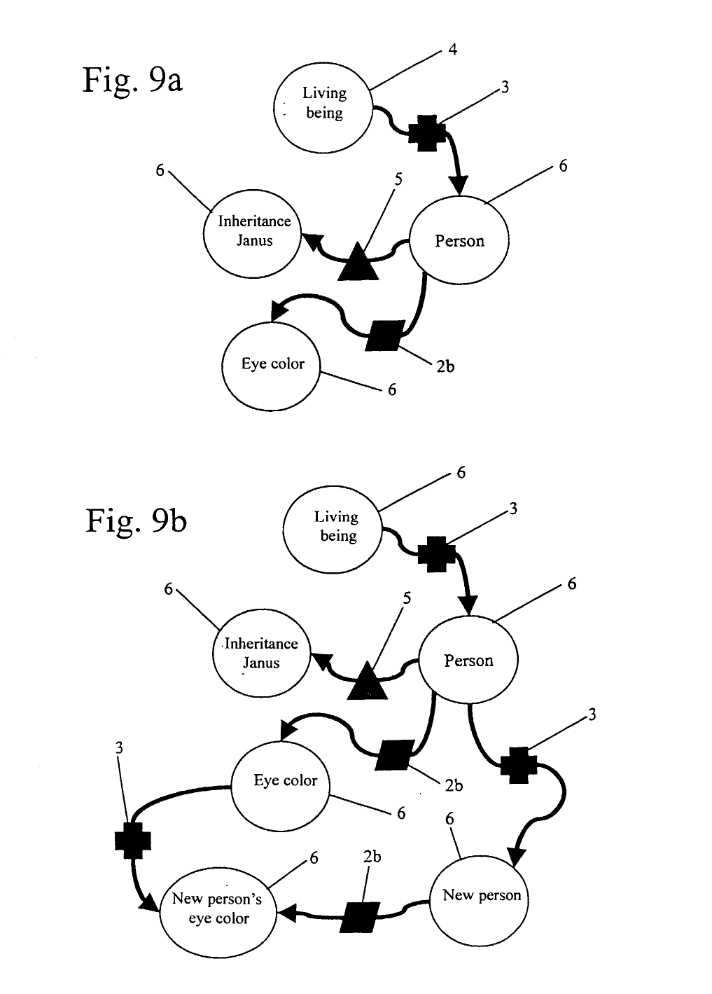

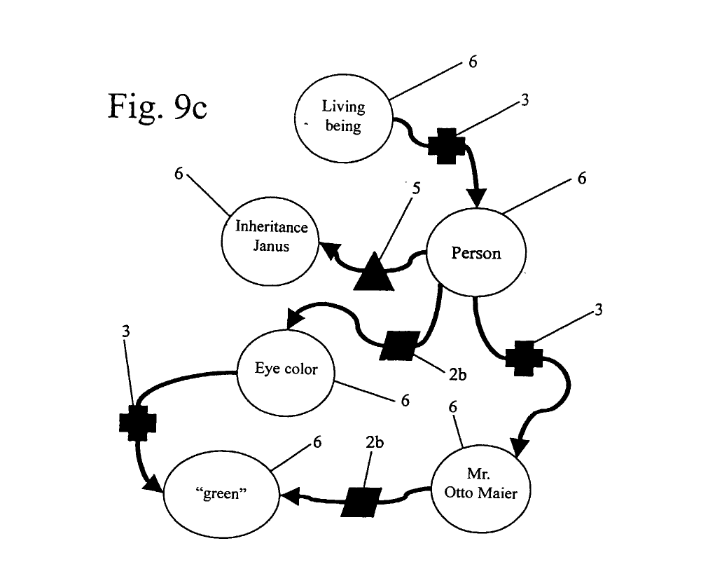

FIGS. 9a to 9c are representations of a semantic network in accordance with a fifth embodiment of the present invention.

The following is a description of embodiments of the present invention.

Before describing in detail the embodiments of the present invention, the following is to be noted. Generally speaking, an nth-order fractal network for handling complex structures is comprised of a multiplicity of units. The fractal network contains both semantic units each possessing informational contents, and linking units describing a relational content. The relational content links two respective semantic units in such a way that the mutual relation of the two linked semantic units is determined by the relational content. The term “semantic” here is meant to denote “carrying meaning”.

The like linking units may represent a particular form of semantic units which may possess informational contents and relational contents.

Apart from a combination of semantic units through linking units, there moreover is the possibility of one or several linking units in turn being linked through one or several respective linking units with one or several semantic units, and/or one or several linking units in turn being linked through one or several linking units with one or several linking units, as will become evident from the following description.

Such relational contents of linking units may as a general rule be selected freely by a user. It is, however, sensible to preliminarily define some elementary relational contents of linking units in a basic library. Conceivable elementary relational contents of linking units are exchange relations and relations. Exchange relations are defined as those relations describing an abstract, material and/or communicative exchange between semantic units. Relations, on the other hand, are those relational contents of linking units which describe relations of some kind between semantic units.

FIGS. 1a to 1e show several such elementary linking units describing a respective relational content.

In the case of hierarchically structured knowledge, such as in the fractal network, linking units of the exchange relation type may be further subdivided into two groups.

What is shown in FIG. 1a is a linking unit 1 of the exchange relation type which interconnects semantic units in mutually different hierarchy planes of the nth-order fractal network. What is thus described is the kind of relation of a larger, i.e., superordinate semantic unit with a smaller, i.e., subordinate semantic unit and vice versa. In other words, a scale change is carried out. Linking units having relations which exhibit the two named features, namely, an exchange and a scale change, are hereinafter designated as linking units of the VA/VS type. In the expression “VA/VS”, the expression “VA” accordingly represents “exchange”, and the expression “VS” represents “scale change”. In simple terms, a like linking unit 1 of the VA/VS type may be regarded to be “A contains B” in the direction of the arrow from A to B shown in FIG. 1a, and “B is part of A” in the opposite direction. This corresponds to the definition of an embedding hierarchy.

FIG. 1b shows linking units 2, 2a and 2b of the exchange relation type which interconnect semantic units in same hierarchy planes of the n^{th}-order fractal network. In other words, no scale change is performed. Linking units having relations which exhibit the two named features, namely, an exchange and no scale change, are hereinafter designated as linking units of the VA/VH type. In the expression “VA/VH”, the expression “VA” correspondingly represents “exchange”, and the expression “VH” represents “no scale change”. In simple terms, a like linking unit 2a of the VA/VH type may be regarded to be “A is input quantity of B” in the direction from A to B, and “B is output quantity of A” in the opposite direction, and such a linking unit 2b of the VA/VH type may be regarded to be “A is described by B” in the direction from A to B and “B is attribute of A” in the opposite direction.

In the case of hierarchically structured knowledge, as in the fractal network, linking units of the relation type may also be further subdivided into two groups.

FIG. 1c shows a linking unit 3 of the relation type which interconnects semantic units in mutually different hierarchy planes of the nth-order fractal network. What is thus described is the kind of relation of a more general semantic unit with a more specific semantic unit and vice versa. In other words, a scale change is performed. Linking units having relations which exhibit the two named characteristics, namely, a relation and a scale change, are hereinafter referred to as linking units of the VR/VS type. In the expression “VR/VS”, the expression “VR” accordingly represents “relation”, and the expression “VS” represents “scale change”. In simple terms, a like linking unit 1 of the VR/VS type may be regarded to be “A in particular is B” in the direction of the arrow from A to B shown in FIG. 1c, and “B in general is A” in the opposite direction. This corresponds to the definition of a similarity hierarchy.

FIG. 1d shows linking units 4, 4a, 4b and 4c of the relation type which interconnect semantic units in same hierarchy planes of the nth-order fractal network. In other words, no scale change is performed. Linking units having relations which exhibit the two named features, namely, a relation and no scale change, are hereinafter referred to as linking units of the VR/VH type. In the expression “VR/VH”, the expression “VR” accordingly represents “relation”, and the expression “VH” represents “no scale change”. In simple terms, a like linking unit 4a of the VR/VH type may be regarded to be “A is (locally) adjacent B-”, a like linking unit 4b of the VR/VH type may be regarded to be “A is similar to B”, and a like linking unit 4c of the VR/VH type may be regarded to be “B follows after A” in the direction from A to B and “A is followed by B” in the opposite direction.

FIG. 1e moreover shows another linking unit 5 which may be regarded to be “A has Janus/function B” in the direction from A to B and “B is Janus/function of A” in the opposite direction. For a more detailed description of this linking unit 5, reference is made to the description of the embodiments further below.

Finally it should be noted that evidently linking units may both be directional, i.e., directed, and bidirectional, i.e., non-directional.

The following is the description of a first embodiment of the present invention.

FIG. 2 shows a simple fractal network whereby the cooperation of above explained linking units with further semantic units present in the fractal network is illustrated.

In FIG. 2, reference symbol 3 designates a linking unit of the VR/VS type, reference symbol 4b designates a linking unit of the VR/VH type, and reference symbols 6 designate respective semantic units.

If, now, the phrase “man in general is mammal” is to be represented in the “world knowledge” existing in the form of a fractal network, then the semantic units 6 designated by “man” and “mammal” are linked with each other by the directional, i.e. directed, linking unit 3 of the VR/VS type, more precisely of the “is in general/is in particular” “type. If moreover the statement is to be added that “simian and man share a 95% similarity in the context of gene analysis”, the semantic unit 6 designated as “simian” is linked with the semantic unit 6 designated as “man” by a bidirectional linking unit 4b of the VR/VH type, more precisely of the type “is similar to”. The linking unit 4b has in its informational content a weighting of 95%. Linking unit 4b is moreover linked with the semantic unit 6 designated as “gene analysis” through a linking unit (not previously explained) of the type “in the context”.

FIG. 3 shows structured informational contents and relational contents of the semantic units and linking units shown in FIG. 2.

The upper part of FIG. 3 shows the informational contents of the respective semantic units of FIG. 2 which contain an identification, a name and identifications of the linking units connected with them. Thus the semantic unit 6 designated as “man” in FIG. 2 has an identification “1” and the name “man” and is linked with linking units having identifications “12” and “13”. The semantic unit 6 designated as “mammal” in FIG. 2 has an identification “2” and the name “mammal” and is linked with the linking unit having the identification “12”. The semantic unit 6 designated as “simian” in FIG. 2 has an identification “3” and the name “simian” and is linked with the linking unit having the identification “13”. The semantic unit 6 designated as “gene analysis” in FIG. 2, finally, has an identification “4” and the name “gene analysis” and is linked with a linking unit having the identification “134”.

In the lower part of FIG. 3, the relational contents of the respective linking units of FIG. 2 are shown which contain an identification, a name, identifications of the linking units possibly connected with them, identifications of the semantic units or linking units linked by them, and the type of that combination. Thus the linking unit 3 shown in FIG. 2 has the identification “12” and the name “is in general”; it is not connected with any other linking unit and directionally links the semantic unit having identification “1” with the semantic unit having. identification “2”. The linking unit 4b shown in FIG. 2 has the identification “13” and the name “is similar to”; it is connected with the linking unit having identification “134” and bidirectionally links the semantic unit having identification “1” with the semantic unit having identification “3”, wherein it contains a 95% weighting. The linking unit “in the context” shown in FIG. 2, finally, has the identification “134” and the name “in the context”; it directionally links the linking unit 13 with the semantic unit 4.

A graphic representation of the contexts shown in FIG. 3 accordingly results in the representation of the fractal network in FIG. 2.

In general it should be noted that the informational content described by a semantic unit represents a characterization and/or an enumeration of those linking units connecting this semantic unit with other semantic units, with the characterization preferably being a name or a serial number, and the informational content preferably also being present in a structured form.

The linking units describe relational contents which, besides an informational content, also contain a linking identification. This linking identification describes the respective characterization of the semantic units and/or linking units whereby they are linked, one or several indications of direction in relation to these linked semantic units and/or linking units, and/or weightings of the one or two indications of direction.

As can be seen from the first embodiment, there is moreover the possibility of a linking unit being linked with a semantic unit through another linking unit. Moreover the relational content of the linking unit may optionally contain information about the respective type of linking of the interrelated semantic units, with this type of linking optionally containing additional information about a relation, i.e., a comparison of the respective linked units, and/or about an exchange relation, i.e., a uni- or bilateral interaction of the linked units, with the type of linking moreover containing additional information about whether or not a scale change takes place. In an exchange relation, this information concerning a scale change may describe the type of relation with a larger, i.e. superordinate, or smaller, i.e. subordinate, semantic unit or vice versa, or the type of relation with a more general semantic unit or a more specific one.

FIGS. 4a and 4b show further fractal networks in accordance with the first embodiment of the present invention, which serve to facilitate comprehension.

FIG. 4a shows a fractal network wherein a semantic unit 6 designated as “wood” is linked through a linking unit 3 of the VR/VS type, more precisely of the “is in general/is in particular” type, with a semantic unit 6 designated as “segment”, wherein the linking unit 3 of the VR/VS type furthermore contains a weighting of 70% to result in the statement “segment has a 70% wood classification”. Here the linking unit of the VR/VS type may more accurately be designated as VR/VS(+), for evidently the result is a scale change towards a smaller scale from the semantic unit 6 designated as “wood” to the semantic unit 6 designated as “segment”, with the smaller scale in the present application example resulting from a smaller degree of indeterminacy in the attributes of “wood” and “segment” which are not described in any further detail. In the above example a similarity hierarchy is formulated, so that in a case of indeterminate representation of knowledge of the weighting (here: 70%) in the informational content, the linking unit receives the function of a measure for the association to a corresponding class (here: “wood”). When one now moreover regards the linking unit 1 of the VA/VS type, more precisely “consists of/is part of”, then the statement “wood consists of trees” is created, implicitly expressing that a tree is substantially smaller than a wood and is thus situated on a lower or finer scale.

FIG. 4b shows a fractal network wherein a semantic unit 6 designated as “Peter” is linked through a linking unit 4 of the VR/VH type with a semantic unit 6 designated as “Paul”. Moreover the linking unit 4 of the VR/VH type is linked through a linking unit 2b of the VA/VH type, more precisely of the type “is described by/is attribute of”, with a semantic unit 6 designated as “friendship”. Thus in the final outcome the statement “Peter and Paul are friends” is obtained inasmuch as the linking unit 2b, with the aid of the semantic unit 6 designated as “friendship”, more closely describes an abstract exchange (“friendship”).

Finally it should be noted that with the aid of linking units of the VR/VH type, i.e., relations without a scale change, associations and comparisons can be defined. Here it is frequently useful to interpret the weighting in the informational content of the linking unit as a measure for the similarity of the linked semantic units. Examples herefor are the statements, “man shares a 95% similarity with simian” and “winter is followed by spring”.

FIG. 5 shows structured informational contents of semantic units with attributes in accordance with the first embodiment of the present invention.

Every semantic unit may file data and functions of any form in its informational content. In accordance with the first embodiment of the present invention, the name of the semantic unit and its identification have already been described. In addition, informational contents of the semantic units and/or linking units may, besides or instead of static data, also contain algorithms, functions and/or mathematical formulae.

Moreover there equally exists the possibility of semantic units containing informational contents which represent attributes, with these attributes more closely describing other semantic units or linking units (see, for example, the semantic unit 6 in FIG. 4b designated as “friendship”). The fractal network here includes specific linking units which have the function of accomplishing the combination of semantic units which represent attributes with those semantic and/or linking units to which these attributes are associated (see, for example, linking unit 2b in FIG. 4b). These particular linking units 2b are designated by “is described by/is attribute of”.

These attributes may, for example, contain values which are elements from a set, a range, an list or some other ordered or inordinate structure. This ordered or inordinate structure may be formed by one or several figures, sectors in n-dimensional spaces, text data, image data, video data, audio data, calendar data, tables, geometry data, geographical data, fuzzy-logic sets, Internet contents or bundled data or a combination of these, so as to be able to advantageously store world knowledge”. One example for this is represented in FIG. 5, with a more detailed description of the figure being omitted on account of its self-descriptive character.

The description of a second embodiment of the present invention will be given in the following.

One essential feature of the second embodiment of the present invention is the possibility of incorporating specific semantic units into the fractal network, which are capable of performing certain operations on other semantic units. These specific semantic units shall hereinafter be referred to as semantic Janus units.

In the present context, a semantic Janus unit 6 (see FIG. 6) designates a specific semantic unit presenting an algorithm or a collection of algorithms which can alter the informational content of semantic units and/or create new semantic units or destroy existing semantic units, respectively. A semantic Janus unit is connected through a respective specific linking unit 5 (see FIG. 1e) of the type “has Janus/function/is Janus/function of” with one or several semantic units in whose vicinity the semantic Janus unit is to operate.

This means that the functionality of the semantic Janus unit is limited to a degree of merely being capable of performing the particular operations on those semantic units which are located in a predetermined vicinity range of a semantic unit linked therewith. Moreover a semantic Janus unit may be linked, through one or several linking units, with further semantic Janus units and/or with attributes.

In detail, a semantic Janus unit can perform one or several of the following operations: creating new semantic units; bundling already existing semantic units into a single semantic unit which possibly is to be newly generated; altering and/or deleting already existing semantic units; comparing existing semantic units; recording and altering values of the attributes of semantic units; performing an algorithm and/or calculating a function; recording a Janus or part of a Janus, i.e., classification of an algorithm or of part of an algorithm.

The essential task of a semantic Janus unit consists in bundling and contexting informational contents. Bundling here is to be understood as the calculation of informational contents of a semantic unit serving as a center from the informational contents of adjacent semantic units. Contexting is to be understood as the analogously inverse process for bundling, i.e., informational contents of the adjacent semantic units are altered in dependence on the informational contents of the semantic unit serving as a center, with the latter defining the vicinity. In this way it is, e.g., possible in a simple manner to constantly obtain up-to-date statistics of a set of semantic units (bundling), or to immediately pass on changes of basic conditions to a set of semantic units (contexting).

FIG. 6 represents an nth-order fractal network which is used to enlarge on the explanations given above with respect to the second embodiment of the present invention.

The fractal network in FIG. 6 has the purpose of correctly averaging a current average income in dependence on respective basic conditions.

More precisely, FIG. 6 shows a semantic unit 6 designated as “law firm MM” linked, through one linking unit 1 of the VA/VS type each, with the semantic units 6 designated as “Mueller” or “Maier”, respectively, whereby linkages of the type “law firm MM contains Mueller/Mueller is part of law firm MM” and “law firm MM contains Maier/Maier is part of law firm MM” are created. In this embodiment of the present invention, the semantic unit 6 designated as “law firm MM” is connected through a linking unit 5, namely a linking unit of the type “has Janus/function/is Janus/function of”, with a semantic unit 6 designated as “bundle” which in this embodiment of the present invention accordingly acts as a semantic Janus unit with respect to the semantic unit 6 designated as “law firm MM”. The function of input quantity of this semantic Janus unit is fulfilled by the attribute type to be bundled, namely, in the case of the present embodiment the income made up of the individual incomes of the firm. The function of output quantity of the semantic Janus unit is fulfilled by an attribute into which the average income is written. An essential advantage of this kind of statistic data resides in the fact that when an attorney is added to or removed from the firm, changes to the method for calculating the average income are not necessary.

The following is a description of a third embodiment of the present invention.

One essential advantage of the above described Janus unit is the fact that it only acts locally, within a defined vicinity. It is accordingly important to define the term “vicinity” more accurately, which is done in this third embodiment of the present invention.

The term vicinity is closely related with the term distance. A first semantic unit is defined to be adjacent to a second semantic unit when a distance between them is smaller than a predetermined or calculated value, i.e., a limit value. Herein a measure of the distance is dependent on informational and/or connotational contents of the semantic units through which the second semantic unit can be reached starting out from the first semantic unit.

For example it is possible to calculate the measure of the distance with weightings in linking units, with the type of linking unit also entering into this calculation.

FIGS. 7a and 7b show a simple example for such use of a distance measure in accordance with the third embodiment of the present invention.

In accordance with the fractal network shown in FIG. 7a, the problem to be solved is to determine the vicinity of circle of friends of the semantic unit 6 designated as “Paul”. This is accomplished by proceeding only via linking units 7 of the type “is friends with”, wherein it is assumed that the weighting of the linking units 7 of the type “is friends with” is indicated as a measure for friendship, and friends of friends are also counted as belonging to the circle of friends.

Weighting of the linking units 7 of the type “is friends with” may, for example, be transformed into a distance with the aid of a logarithmic function. Thus the distance between the semantic unit 6 designated as “Paul” and the semantic unit 6 designated as “Peter” is, for example:

d(Paul, Peter)=−log(0.8)=0.10

If, now, a limit for a maximum distance of 0.2 is fixed in the semantic Janus unit 6 which is designated as “obtain circle of friends” and obtains the circle of friends of the semantic unit 6 designated as “Paul”, the resulting circle of friends of the semantic unit 6 designated as “Paul” in this embodiment are the semantic unit 6 designated as “Peter” and having a distance of 0.1, the semantic unit 6 designated as “Mary” and having a distance of 0.07, and the semantic unit 6 designated as “Jakob” and having a distance of 0.12. Not contained in the circle of friends, however, is the semantic unit 6 designated as “Anne” having a distance of 0.25.

Herein the distance of the semantic unit 6 designated as “Paul” from the semantic unit 6 designated as “Jakob” is calculated as follows:

d(Paul, Jakob)=d(Paul, Mary)+d(Mary, Jakob)−log(0.85)−log(0.9)=−log(0.85*0.9)=0.12

The aforementioned calculation is analogously valid for the distance of the semantic unit 6 designated as “Paul” from the semantic unit 6 designated as “Anne”. More precisely, in order to determine the distance, the respective weightings of linking units 7 of the type “is friends with” are multiplied. Herein the circle of friends may change without it being necessary to alter the method for calculating the circle of friends.

If, now, a semantic unit 6 designated as “Paul's circle of friends” is to be formed which may, for example, be returned as a response to the fractal network as a result set of an inquiry, then it is necessary in accordance with the representation of FIG. 7b to create this semantic unit 6 designated as “Paul's circle of friends” from the semantic Janus unit 6 designated as “obtain circle of friends” and link it with the corresponding semantic units 6 designated by names. Here it should be noted that the semantic units 6 designated by names, which are contained in the circle of friends, namely, in accordance with the present embodiment the semantic units 6 designated as “Paul”, “Mary” and “Jakob”, are automatically linked through linking units 1 of the VA/VS type, more precisely of the type “contains/is part of”, with the semantic unit 6 designated as “Paul's circle of friends” as is represented by dashed lines in FIG. 7b.

As was described above, in accordance with the present embodiment a distance function is employed to specify the distance between two respective semantic units. Although a particular mathematical function, i.e., the previously mentioned logarithmic function, was used in this embodiment for determining the distance from the weighting of linking units, it is noted that other suitable mathematical functions of a variable parameter G may be fixed as the distance function, with this parameter G being present in each linking unit and expressing the strength of linking of respective semantic units.

The following is a description of a fourth embodiment of the present invention.

In order to provide for expansion of the knowledge existing in a fractal network, it is necessary to—preferably automatically—link new input data with already existing knowledge. For this reason, the input data must be present in the form of semantic units, i.e., semantic input units must exist. The latter must furthermore possess an identification differentiating them from the semantic units of the knowledge already present in the fractal network. By means of an iterative classification or identification process, linking units of the VR/VS or VR/VH type are generated between the semantic input units and the associated semantic units of the knowledge. Classification/identification here means that the informational content of each input data is put into relation with one or several corresponding semantic units of the knowledge. Weighting of the relation is a measure for the association of the input units with the corresponding semantic unit of the knowledge.

FIGS. 8a and 8b show a classification/identification process of a phrase in a semantic network in accordance with the fourth embodiment of the present invention. More precisely, FIG. 8a shows a start situation and FIG. 8b shows a result situation.

The example used is the phrase, “Der Schlüssel steckt im Schloβ” [The key is inserted in the lock]”, the meaning of which cannot be deduced without background knowledge, for “Schloβ” may be a locking mechanism [lock] on the one hand and a building [castle] on the other hand.

It is now the task of the semantic Janus unit 6 shown in FIG. 8a and designated as “classification Janus” to correctly link the semantic unit 6 designated as “Schloβ” [lock; castle] on the left-hand side of this figure with the world knowledge present in the fractal network. This is accomplished, for example, by realizing through a syntactic preliminary analysis that the semantic units 6 designated as “Schlüssel” [key] and “Schloβ” [lock] on the left-hand side of FIG. 8a are related with each other through the semantic unit 6 designated as “stecken” [being inserted]. In the world knowledge already present in the fractal network, on the other hand, a semantic unit 6 designated as “Schlüssel” [key] on the right-hand side of FIG. 8a is connected through a relation of the VR/VH type, which is not described more closely, with the semantic unit 6 designated as Schloβ” [lock] on the right-hand side of FIG. 8a which represents a particular locking mechanism. Moreover this semantic unit 6 designated as “Schlüssel” [key] on the right-hand side of FIG. 8a is, however, not connected with the semantic unit 6 designated as “Schloβ” [castle] on the extreme right side of FIG. 8a which represents a particular building.

When a vicinity analysis of the semantic units 6 designated as “Schlüssel” [key] and “Schloβ” [lock; castle] and of their linking units in the world knowledge is now carried out by the semantic unit 6 designated as “classification Janus”, it is found that the semantic input units 6 designated as “Schloβ” [lock; castle) on the left-hand side in FIG. 8a is classified as a semantic unit “Schloβ” [lock] which is a particular locking mechanism. As the outcome of the vicinity analysis, frequently also referred to as context, the semantic unit 6 designated as “stecken” [being inserted] is correspondingly classified as a special case of the relation 2 between the semantic units 6 designated as “Schlüssel” [key] and “Schloβ” [lock; castle], which is not further defined in the world knowledge present in the fractal network. This clearly reveals the advantages of the semantic unit 6 designated as “classification Janus”. Not only can the semantic unit 6 designated as “Schloβ” [lock; castle] on the left side in FIG. 8a be classified correctly, but it can also be learned that “being inserted” is a possible relation between the semantic units 6 designated as “Schlüssel” [key] and “Schloβ” [lock], as is shown by the dashed lines in FIG. 8b that represents the result situation. This figure moreover reveals that the new knowledge acquired by learning may thus also be incorporated into the knowledge present in the fractal network.

In summary, it can be said that semantic units and/or parts of the fractal network are classifiable. This classification is performed in such a manner that the one measure is determined which indicates how well the respective semantic units or the partial fractal network, respectively, fit in the current location, and/or the one location is determined in which the respective semantic units or the partial fractal network, respectively, fit particularly well. Preferably the semantic units contain a marking which indicates whether it is a new input unit or an already existing semantic unit, with input units optionally being present as a partial fractal network and/or optionally not yet being connected with the fractal network through linking units. Incorporation of a new semantic unit or of a new partial network into the fractal network is carried out while taking into account the classification. These new semantic units can be linked with a start-Janus unit. Moreover there is also the possibility of imposing restrictions on the semantic units and/or linking units with a view to those kinds of units they can be linked with. Although this was not mentioned above, one or several input/output devices may equally be provided, whereby the fractal network or part of it may be input or output.

The following is a description of a fifth embodiment of the present invention.

It is a frequent case that an instance of a semantic unit is to be generated which is a special case of that semantic unit. In this case, it is possible to refer to the semantic unit as a parent and to the specific instance as a child. Herein a generated child is to inherit part of its parent's vicinity. A fractal network handling this case is shown in FIGS. 9a to 9c. Here it is useful if a semantic Janus unit 6 referred to as “inheritance Janus” in FIGS. 9a to 9c and connected with the parent carries out the generation and inheritance processes. In accordance with the representation in FIG. 9c, the informational contents of the newly created semantic units may be overwritten with informational contents originating from input data or other sources.

More precisely, the semantic unit 6 shown in FIGS. 9a to 9c and designated as “inheritance Janus” applies, for example, the following process.

The “inheritance Janus” selects a vicinity around the parent to which it is connected. A vicinity may be defined in various ways and manners, e.g., in that it is only allowed to proceed by way of linking units of the VA/VS type(+), “is described by”, and “has Janus/function of”, and that only immediate neighbors may be selected. In the specific application, the vicinity of the “person” is defined in that it is only allowed to proceed by way of linking units of the type “is described by”, i.e. that “eye color” is located in the selected vicinity of the “person”, however “living being” is not located in the selected vicinity of the “person” (see FIG. 9a). Here it is to be noted, however, that other vicinities suited for the respective application may also be defined.

Subsequently a semantic unit “child” (“new person” in FIG. 9b) is generated which is a particular instance of the semantic unit “parent” (“person” in FIG. 9b). The “child” is linked with the “parent” through a linking 3 of the VR/VS(+) type. After this, children are also generated for all semantic units from the selected vicinity. These children are also linked with their respective parents through linkings of the VR/VS(+) type. In the embodiment, the child “eye color of the new person” is thus created and linked with the semantic unit “eye color” (see FIG. 9b). All children are finally linked among each other in accordance with their respective parents' linking. In the embodiment, the children “new person” and “eye color of the new person” are thus linked with each other by linking unit 2b (see FIG. 9b).

In conclusion, the informational contents of the children may be overwritten with informational contents from input objects or other sources. In the exemplary application, the child “new person” is overwritten with “Mr. Otto Maier”, and the child “eye color of the new person” with “green” (see FIG. 9c).

In general it may be said that the invention explained above in detail by way of illustrating embodiments for example provides particular advantages in distributed computer systems (such as networks, INTRANET, INTERNET etc.), wherein the information objects and linking objects may be distributed over a multiplicity of computer systems (processors) and storage systems. As a result, for example, many users (world-wide) thereby have the possibility of accessing, constructing and using a like n^{th}-order fractal network. Typical applications herefor are (multimedia) document management systems, geographical information systems with heterogeneous structured data and meta-data, data describing contents and structure of data blocks, as well as project management systems for structuring and monitoring business processes.

Moreover the above described fractal network according to the invention is suited not only for treating, e.g., speech data, image data or network structures, but also for handling so-called chaotic systems describing, e.g., technical, cultural, economic or ecological contexts. The complex structures may moreover be both static and dynamic, wherein analyzing and/or treating the complex structures may in particular encompass describing, searching, altering and/or simulating.

As regards further features and advantages of the present invention, reference is specifically made to the disclosure of the drawing.

1. A fractal network for handling complex structures, wherein the fractal network is comprised of a multiplicity of units, characterized in that said fractal network contains
semantic units each possessing informational contents, as well as
linking units describing a relational content which links two respective semantic units in such a way that the mutual relation of the two linked semantic units is determined by the relational content.

2. A fractal network according to claim 1, characterized in that the linking units are a particular form of semantic units which may possess informational contents and relational contents.

3. A fractal network according to claim 1 or 2, characterized in that the informational content described by a semantic unit represents a characterization and/or an enumeration of those linking units connecting this semantic unit with further semantic units.

4. A fractal network according to claim 3, characterized in that the characterization described by the informational content is a name and/or a serial number.

5. A fractal network according to claim 3, characterized in that the enumeration described by the informational content is present in a structured form.

6. A fractal network according to any one of claims 1 to 5, characterized in that besides the informational content, the relational content described by a linking unit additionally contains a linking characterization describing the respective characterization(s) of the semantic units linked by them, one or two indications of direction in relation to these linked semantic units, and/or weightings G of the one or two indications of direction.

7. A fractal network according to any one of claims 1 to 6, characterized in that moreover one or several linking units may in turn be linked with one or several semantic units through one or several respective linking units, and/or one or several linking units in turn may be linked with one or several linking units through one or several linking units.

8. A fractal network according to any one of claims 1 to 7, characterized in that the relational content of a linking unit optionally contains information about the respective type of linking of the interrelated semantic units.

9. A fractal network according to claim 8, characterized in that the type of linking described by a linking unit optionally moreover contains information about a relation VR, i.e., about a comparison of the respective linked units, and/or about an exchange relation VA, i.e., about a uni- or bilateral interaction of the linked units.

10. A fractal network according to claim 8 or 9, characterized in that the type of linking described by a linking unit additionally contains information about whether a scale change VS takes place in the type of linking or whether no scale change VH takes place.

11. A fractal network according to any one of claims 8 to 10, characterized in that the relational content of a linking unit contains information about the respective type of linking, consisting of the pairs VS/VR, VS/VA, VH/VR or VH/VA.

12. A fractal network according to claim 10 or 11, characterized in that the scaling information VS has the function of describing the type of relation with a larger, i.e., superordinate, or with a smaller, i.e., subordinate semantic unit.

13. A fractal network according to claim 10 or 11, characterized in that the scaling information VS has the function of describing the type of relation with a more general or more specific semantic unit.

14. A fractal network according to any one of claims 1 to 13, characterized by a distance function indicating the semantic distance between two respective semantic units.

15. A fractal network according to claim 6 and 14, characterized in that the distance function is determined through a suitable mathematical function of a variable parameter G which may be present in several linking units and expresses the strength of the mutual linking.

16. A fractal network according to any one of claims 1 to 15, characterized in that the informational contents of the semantic units and/or linking units, besides or instead of optionally static data, also contain algorithms and/or functions and/or mathematical formulae.

17. A fractal network according to any one of claims 1 to 16, characterized in that the informational contents of at least some of the semantic units constitute attributes more closely describing further semantic units or linking units.

18. A fractal network according to claim 17, characterized in that the network furthermore contains specific linking units having the function of establishing the linking of semantic units constituting attributes with those semantic units and/or linking units to which these attributes are associated.

19. A fractal network according to claim 17 or 18, characterized in that the attributes optionally contain values which are elements from a set, a range, a list or another ordered or inordinate structure.

20. A fractal network according to claim 19, characterized in that the ordered or inordinate structure constituting the respective attribute is formed by figures, calendar data, audio data, video data, text data, tables, image data, geometry data, fuzzy-logic sets or bundled data or a combination of these.

21. A fractal network according to any one of claims 1 to 20. characterized in that the network additionally contains specific semantic units, Janus units, which are capable of carrying out specific operations on further semantic units.

22. A fractal network according to claim 21, characterized in that each Janus unit is linked with one or several further semantic units through one or several linking units, with the functionality of the Janus unit being restricted so as to be only capable of performing the specific operations on those semantic units located in a predetermined vicinity range of this one or these several linked semantic unit(s).

23. A fractal network according to claim 21, characterized in that a Janus unit is optionally linked with one or several further Janus units through one or several linking units.

24. A fractal network according to any one of claims 21 to 23, characterized in that a Janus unit is capable of carrying out one or several of the following operations: creating new semantic units; bundling already existing semantic units into a single semantic unit possibly to be newly created; altering and/or deleting already existing semantic units; comparing existing semantic units; recording and altering the values of attributes; executing an algorithm and/or calculating a function; recording and/or altering algorithms; recording a Janus or a part of a Janus.

25. A fractal network according to any one of claims 1 to 24, characterized in that semantic units and/or parts of the fractal network can be classified.

26. A fractal network according to claim 25, characterized in that classification is carried out by determining the one master dimension that indicates how well the respective semantic units or the partial fractal network, respectively, fit in a given location, and/or by determining those locations in the fractal network in which the respective semantic units or the partial fractal network, respectively, fit particularly well, wherein it is possible to jointly indicate the respective master dimensions.

27. A fractal network according to any one of claims 1 to 26, characterized in that the semantic units contain a marking which indicates whether it is a matter of a new input unit or of an already existing unit, with input units optionally being present as partial fractal networks and/or optionally not yet being connected with the network through linking units.

28. A fractal network according to claim 26 and 27, characterized in that incorporation of a new unit or of a new partial network, respectively, into the fractal network is carried out by taking into consideration the classification.

29. A fractal network according to claim 27 or 28, characterized in that new semantic units can be linked with a start-Janus unit.

30. A fractal network according to any one of claims 1 to 29, characterized in that restrictions can be imposed on the semantic units and/or linking units regarding those kinds of units with which they may be linked.

31. A fractal network according to any one of claims 1 to 30. characterized by one or several input/output devices for inputting and outputting, respectively, the fractal network or part thereof.
